(19) United States
(12) Patent Application Publication
(10) Pub. No.: US 2017/0363068 A1
(43) Pub. Date: Dec. 21, 2017

(54) Systems and Methods for Offshore Power Generation Using Airborne Power Generating Craft

(71) Applicants: Christopher G. Hart, Conroe, TX (US); Donald P. Bushby, Spring, TX (US); Brandon Cassimere, Houston, TX (US)

(72) Inventors: Christopher G. Hart, Conroe, TX (US); Donald P. Bushby, Spring, TX (US); Brandon Cassimere, Houston, TX (US)

(21) Appl. No.: 15/595,332

(22) Filed: May 15, 2017

Related U.S. Application Data
(60) Provisional application No. 62/351,528, filed on Jun. 17, 2016.

(51) Int. Cl. F03D 13/20; F03D 5/00

(52) U.S. Cl. CPC F03D 13/20; F03D 5/00; F05B 2240/921; F05B 2240/917; F05B 2240/922; F05B 2240/92

(57) ABSTRACT

A method of generating power using an airborne power generating craft connected to an anchor using a tether line. The anchor is secured to an underwater floor. Power is generated based on movement of the airborne power generating craft in response to a wind force. A constant length of the tether line is maintained between the airborne power generating craft and the anchor as the airborne power generating craft moves in response to the wind force. The airborne power generating craft is connected to an electrical transmission system through at least part of the tether line. The generated power is transmitted to the electrical transmission system.

### CROSS-REFERENCE TO RELATED APPLICATIONS

This application claims the priority benefit of U.S. Patent Application No. 62/351,528 filed Jun. 17, 2016 entitled SYSTEMS AND METHODS FOR OFFSHORE POWER GENERATION USING AIRBORNE POWER GENERATING CRAFT, the entirety of which is incorporated by reference herein.

This application is related to U.S. Provisional Patent Application No. 62/351,541, entitled “Systems and Methods for Offshore Power Generation Using Airborne Power Generating Craft Tethered to a Floating Structure”; U.S. Provisional Patent Application No. 62/351,547, entitled “Methods and Systems of Maintaining an Offshore Power Plant”; U.S. Provisional Patent Application No. 62/351,550, entitled “Methods and Systems for Electrical Isolation in an Offshore Power Generation Plant” and U.S. Provisional Patent Application No. 62/351,552, entitled “Method and Systems for Maintaining an Offshore Power Plant Having Airborne Power Generating Craft”, all of which are filed on an even date and have a common assignee herewith, the disclosures of which are incorporated by reference herein.

### BACKGROUND

### Field of Disclosure

The disclosure relates generally to offshore power generation, and more particularly, to tethered wind turbine systems.

### Description of Related Art

This section is intended to introduce various aspects of the art, which may be associated with the present disclosure. This discussion is intended to provide a framework to facilitate a better understanding of particular aspects of the present disclosure. Accordingly, it should be understood that this section should be read in this light, and not necessarily as an admission of prior art.

A wind turbine converts the energy of moving air into electricity or other forms of energy. A common type of wind turbine system includes an electrical generator driven by rotor blades mounted in a rotatable manner near an upper end of a vertical support tower. The rotor may be rotated relative to the tower as the wind direction changes such that the blades of the rotor are maintained perpendicular to the wind. These windmill-type wind turbine systems have become popular on land in regions that have open space and sufficient average wind velocities, and have also been adapted for use in offshore locations. Offshore locations offer the benefit of open space and potentially higher average sustained wind speeds.

Concepts for deeper water installations that are currently under development are mostly derived from configurations for offshore oil well rigs to include floating platforms. Accordingly, such concepts typically require large cranes for erection of the towers and turbines and are not optimal for wind turbines because of the large aerodynamic force in the direction of the wind as well as forces associated with dynamics from the angular momentum of the turbine blades. Furthermore, wind and wave forces cause coupled motions of the support tower and the rotor blades, resulting in greater structural dynamic loads, deflections and stresses upon the wind turbine system. The options of the prior art include large costly structures, with masses and/or dimensions often many times that of the wind turbine they are designed to support. For example, a typical offshore wind turbine system may have a height of approximately 100 meters from the sea surface with a weight of hundreds of tons.

One solution to the high cost of installation of wind turbines is an apparatus that is tethered to a fixed point. The apparatus generates electrical power by harnessing the wind in some manner. An example of a tethered wind turbine system is illustrated in FIG. 1 and is indicated generally by reference number 10. System 10 includes a wing or blade 12 fastened to a base 14 using a tether line 16. The blade 12 is shaped to move generally perpendicular to the direction of the blowing wind W in a path, such as circular path 18. The blades may be shaped to perform lift when wind W is passed over it. As the blade moves, propellers 20 mounted on the blade rotate and cause electrical power to be generated by motor/generators 22, to which the propellers are rotatably mounted. The power so generated is transmitted through tether line 16. Blade 12 may be raised and lowered by extending or retracting tether line 16, and may be brought to rest on a mount or cradle 24, which may be an integral part of base 14. System 10 may be launched from its cradle using the motor/generators 22 in a motoring mode. Power transmitted to the motor/generators 22 is used to drive the propellers 20 in the motoring mode. Once at the desired altitude, and when wind velocities are sufficiently high and/or constant, system 10 may autonomously shift to a self-sustained state of flight using lift generated by blade 12, and the motor/generators 22 generate power as previously described. The motor/generators 22 preferably are operated in a motoring mode to control the descent of blade 12 as the blade is returned to rest on cradle 24. System 10 as described has been developed by Makani Power, Inc. of Alameda, Calif.

Because system 10 requires no heavy vertical support tower, the mass of system 10 is significantly less than a similarly rated conventional wind turbine system—perhaps as much as 90% less. Additionally, system 10 may be employed at altitudes of 300 meters or more, potentially harnessing the stronger and more consistent winds there. Such altitudes simply are not commercially accessible by conventional systems using a vertical support tower. At these high altitudes, 85% of the United States can offer viable wind resources compared to the 15% of the United States accessible with conventional wind turbine technology. More importantly, because of the significant weight reductions and the potential for high altitude deployment, system 10 may be advantageously deployed in offshore waters, opening up a resource which is four times greater than the entire electrical generation capacity of the United States.

Current solutions for implementing system 10 offshore require placing base 14 on a semi-submersible structure that is secured to the seafloor with multiple anchoring cables. Such a solution still requires transporting and anchoring the semi-submersible structure, and these activities may reduce the commercial feasibility of system 10. There is a need to reduce the cost of installation and to reduce the capital expenditures required to install wind power at sea, or over a body of water. There is also a need for solutions which enable installations in deeper water which are cost effective and suitable for the harsh deep water conditions. Therefore, it would be desirable to provide an offshore wind turbine system that can easily be installed in deep water locations and that minimizes or eliminates requirements for a foundational support structure at the water's surface.

### SUMMARY

The present disclosure provides an offshore power generation system including an airborne power generating craft. A tether line is connected at a first end to the airborne power generating craft. A second end of the tether line is attached to an anchor, which is secured to an underwater floor. The length of the tether line is constant between the airborne power generating craft and the anchor. An electrical transmission system is connected to the airborne power generating craft through the tether line. The electrical transmission system transmits power generated by the airborne power generating craft.

The present disclosure also provides a method of generating power. An airborne power generating craft is connected to an anchor using a tether line. The anchor is secured to an underwater floor. Power is generated based on movement of the airborne power generating craft in response to a wind force. A constant length of the tether line is maintained between the airborne power generating craft and the anchor as the airborne power generating craft moves in response to the wind force. The airborne power generating craft is connected to an electrical transmission system through at least part of the tether line. The generated power is transmitted to the electrical transmission system.

The foregoing has broadly outlined the features of the present disclosure so that the detailed description that follows may be better understood. Additional features will also be described herein.

### BRIEF DESCRIPTION OF THE DRAWINGS

These and other features, aspects and advantages of the disclosure will become apparent from the following description, appending claims and the accompanying drawings, which are briefly described below.

FIG. 1 is a side elevational view of a known tethered wind turbine system.

FIG. 2 is a side elevational view of a tethered wind turbine system according to disclosed aspects.

FIG. 3 is a perspective view of a portion of the tethered wind turbine system of FIG. 2 according to disclosed aspects.

FIG. 4 is a detail view of a portion of the tethered wind turbine system of FIGS. 2 and 3 according to disclosed aspects.

FIG. 5 is a cross-section view of the tether taken along line 5-5 in FIG. 2 according to disclosed aspects.

FIG. 6 is a detail view of a portion of an anchor pile shown in FIG. 2 according to disclosed aspects.

FIG. 7 is a detail view of a portion of a tether shown in FIG. 2 according to disclosed aspects.

FIG. 8 is a plan view of a wind farm according to disclosed aspects.

FIG. 9 is a side elevational view of a tethered wind turbine system according to disclosed aspects.

FIG. 10 is a perspective view of an offshore support vessel according to disclosed aspects.

FIG. 11 is a side elevational view of a tethered wind turbine system according to disclosed aspects.

FIG. 12 is a side elevational view of a tethered wind turbine system according to disclosed aspects.

FIG. 13 is a schematic diagram of a control system according to disclosed aspects.

FIG. 14 is a side elevational view of a buoy according to disclosed aspects.

FIG. 15 is a side elevational view of a method of transporting a tethered wind turbine system according to disclosed aspects.

FIG. 16 is a method according to aspects of the disclosure.

FIG. 17 is a method according to aspects of the disclosure.

FIG. 18 is a method according to aspects of the disclosure.

FIG. 19 is a method according to aspects of the disclosure.

FIG. 20 is a method according to aspects of the disclosure.

FIG. 21 is a method according to aspects of the disclosure.

FIG. 22 is a method according to aspects of the disclosure.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

To promote an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. For the sake of clarity, some features not relevant to the present disclosure may not be shown in the drawings.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As one of ordinary skill would appreciate, different persons may refer to the same feature or component by different names. This document does not intend to distinguish between components or features that differ in name only. The figures are not necessarily to scale. Certain features and components herein may be shown exaggerated in scale or in schematic form and some details of conventional elements may not be shown in the interest of clarity and conciseness. When referring to the figures described herein, the same reference numerals may be referenced in multiple figures for the sake of simplicity. In the following description and in the claims, the terms “including” and “comprising” are used in an open-ended fashion, and thus, should be interpreted to mean “including, but not limited to.”

The articles “the,” “a” and “an” are not necessarily limited to mean only one, but rather are inclusive and open ended so as to include, optionally, multiple such elements.

As used herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure.

As used herein, terms such as “offshore”, “seafloor”, “subsea”, “underwater”, and “water” are to be interpreted to refer to or describe any body of water, including oceans, lakes, reservoirs, seas, and rivers.

As used herein, the terms “electricity” and “power”, when referring to the generation, transmission, and storage thereof, may be used interchangeably as is known in the art.

The disclosed aspects include a power generation plant having one or more tethered wind turbine systems, coupled with appropriate electrical infrastructure and energy storage technology, which may be configured to power new or existing developments. Such developments are described herein and may include offshore and/or onshore developments.

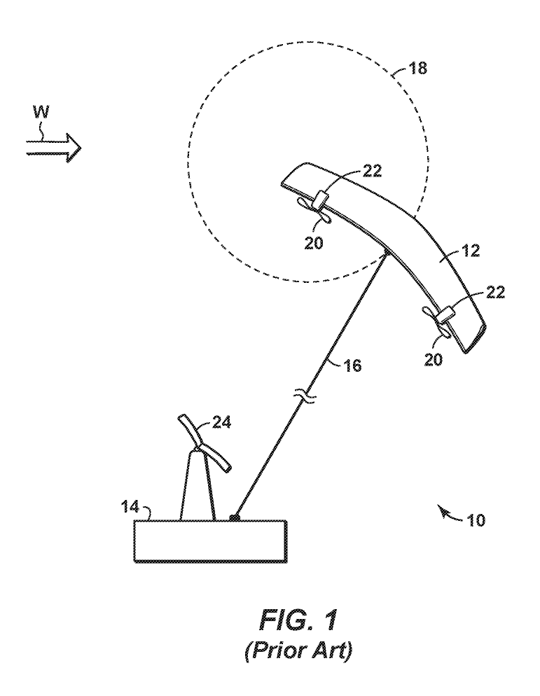

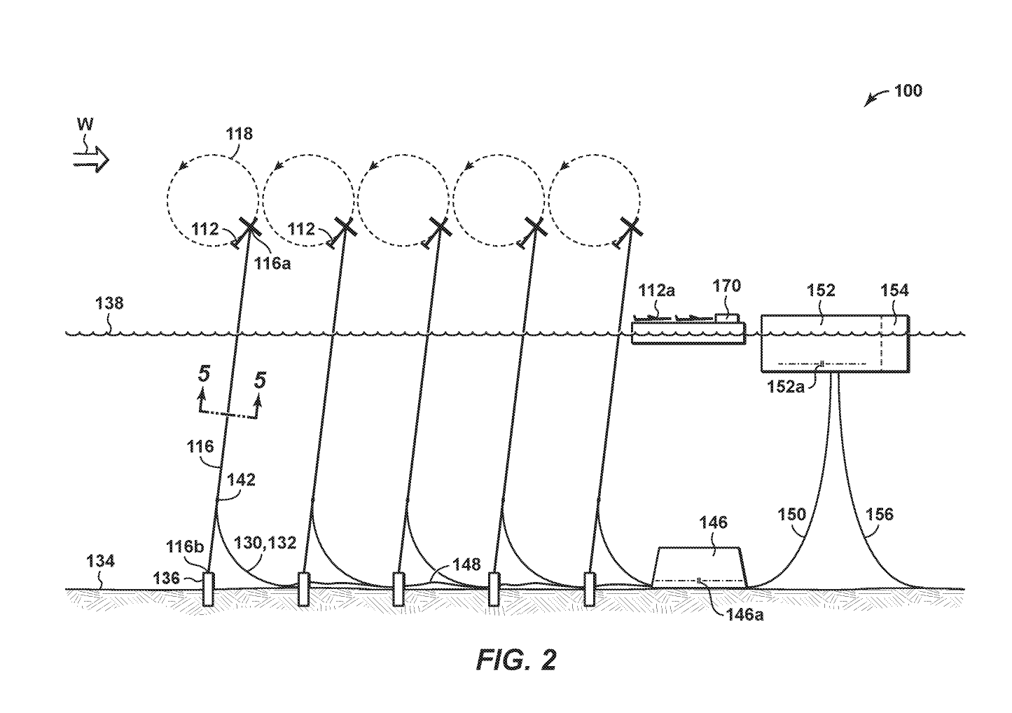

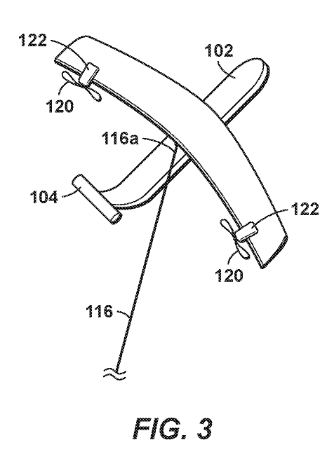

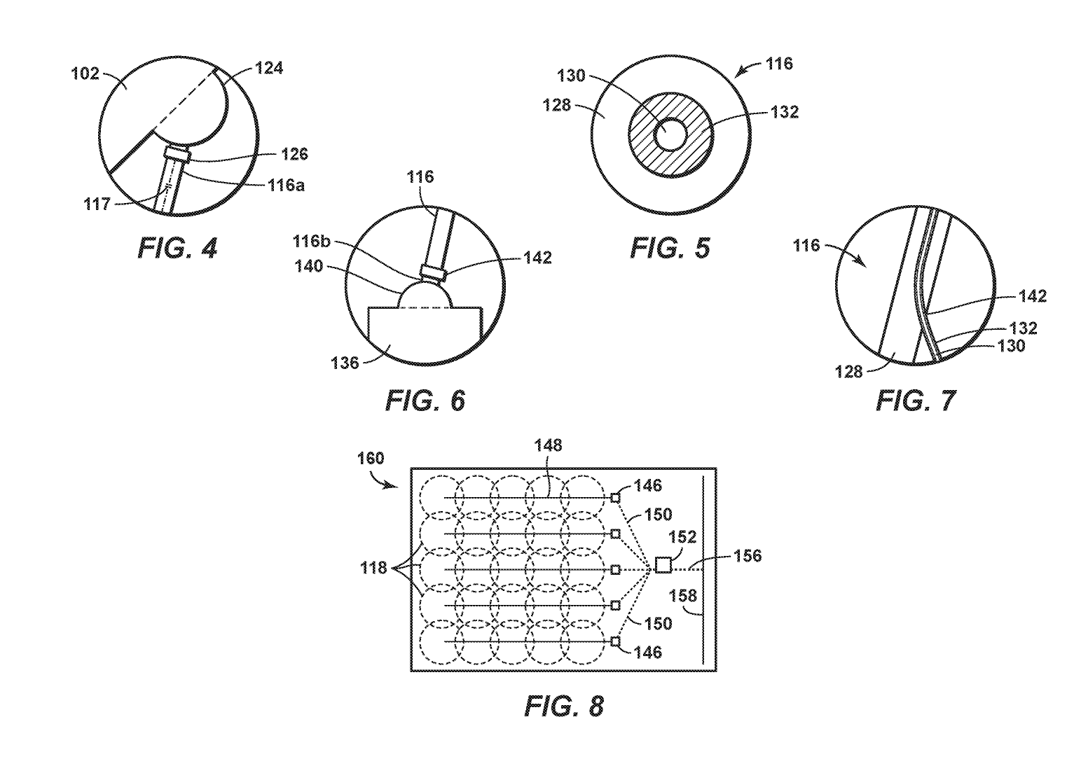

FIG. 2 illustrates a power generation plant 100 according to aspects of the disclosure. Power generation plant 100 includes one or more airborne elements or airborne power generating craft, which in one aspect of the disclosure comprises wings, blades, or kites (collectively identified herein as kites 112). Kites 112 may be similar to the stiff or substantially non-flexible blades disclosed in FIG. 1, or may be at least partially comprised of a flexible material to provide a structure that is rigid, semi-rigid, or non-rigid. For example, kites 112 may flex under the forces of the wind and may be composed of one or more of a rigid material (for example, metal), a semi-rigid material (e.g., carbon fibers), and a non-rigid material (e.g., fabric). FIG. 3 discloses an aspect in which each kite 112 may include an aircraft-like fuselage 102 to which a rear stabilizer 104 may be attached. A first end 116a of each tether line 116 may be attached to a respective one of kites 112. For example, as shown in FIG. 4, first end 116a may be attached to a gimbal 124 or other rotating structure on kite 112. A quick disconnect mechanism 126 may be disposed at or near first end 116a to facilitate rapid disconnection of tether line 116 from kite 112. The quick disconnect mechanism 126 may be configured to be remotely triggered or operated and/or may be manually operated. FIG. 5 shows a cross-section of a tether line 116, which may include a tension element 128 that may be constructed of a material having a high strength-to-weight ratio such as carbon fiber, woven cable made of high-strength, corrosion-resistant steel, or the like. In an aspect, tether line 116 is slightly buoyant or includes buoyant elements to prevent it from sinking to the seafloor when not connected to kite 112. In an aspect, tension element 128 may be made of a material suitable for both subsea (i.e., underwater) and airborne application or deployment. In another aspect, tension element 128 has an underwater component suitable for continuous submersion in a body of water, and an airborne component suitable for use on or above the body of water. The lengths of the underwater and airborne components of tension element 128 may be respectively determined by estimating the depth of the water in which the kite is to be used, and the intended height of kite 112 in operation. Tension element 128 may be designed to surround one or more electrical conduits, shown in FIG. 5 as an inter-array transmission and communications umbilical cable 130. Umbilical cable 130 may permit transmission of electrical current supplied to or generated by kite 112. Umbilical cable 130 may also transmit control and/or diagnostic signals to and/or from the kite 112, as will be described further herein. Additionally or alternatively, the tether line may include fiber optic or other control and communication elements in addition to the umbilical cable. One design for a tether line is described in PCT Patent Publication WO2012/012429, the disclosure of which is incorporated by reference herein. A layer of insulation 132 may surround and protect umbilical cable 130 from the surrounding water.

A second end 116b of tether line 116 may be secured at an anchoring point at or on an underwater floor, such as a lake bed, a river bed, or a seafloor 134, using an anchor pile 136 or similar means. For example, anchor pile 136 may be drilled and grouted, or as shown in FIG. 6, may be a driven pile. Alternatively, a vertical load anchor may be used to secure second end 116b of tether line 116. The anchor pile 136 may be located entirely below the surface of the water 138, as shown in the Figures, but in shallower water part of the anchor pile may be above the surface of the water. A rotating mechanism or element such as a combined gimbal and swivel 140 may be attached to or integrally formed as part of the top of the anchor pile. Second end 116b of tether line 116 may then be attached to the gimbal 140. Tether line 116, so attached, is permitted to rotate about axes parallel and perpendicular to the seafloor 134, to thereby enable kite 112 to freely move relative to the anchor pile 136. A quick disconnect mechanism 142, shown schematically in FIG. 6, is employed at or near the point of connection between the tether line and gimbal to permit the tether to be disconnected and/or replaced if the tether, gimbal, and/or the anchor pile requires maintenance or replacement, or in the event of failure of operations of all or part of the power generation plant 100. The quick disconnect mechanism 142 may be configured to be remotely triggered or operated and/or may be manually operated. A spool or winch may be included at the anchor pile to permit the cable to be reeled in if the tether breaks or the kite crashes. The spool or winch may include a cable tensioner element that allows the tether line to be reeled in regardless of the amount of tension on the tether line.

Kite 112 is designed to move in a path 118, shown as an elliptical or circular path in FIG. 2, in response to the blowing wind W. As the kite moves along the path 118, tether line 116 moves through the water in an oscillating or repeating pattern. Propellers 120 mounted on the kite rotate and cause electrical current to be generated using motor/generators 122, to which the propellers are rotatably mounted. The electrical current so generated is transmitted through umbilical cable 130. The length of each tether line 116 may be selected to enable kites 112 to capture wind energy at a desired altitude, which may exceed 100 meters, or 200 meters, or 300 meters. Each kite may have a nameplate power generation capacity of more than 20 kilowatts, or more than 100 kilowatts, or more than 500 kilowatts, or more than one megawatt, or more than five megawatts.

As illustrated in FIG. 7, umbilical cable 130 and insulation 132 may diverge from the tension element 128 at a point of separation 142, which may be at or close to second end 116b of tether line 116, or which may be at any point along the tether line. The umbilical cables associated with each of the tether lines shown in FIG. 2 are electrically connected in a preferred configuration to an underwater electrical module 146 either directly or by connection to an array line 148. The array line 148 transmits electrical current generated by the motor/generators to the underwater electrical module 146, and transmits communications and control signals between each kite 112 and the underwater electrical module. The underwater electrical module 146 contains the infrastructure necessary for basic voltage transformation, power distribution, breaker switching, power isolation, connecting the umbilical cables 130 to the array line 148, and/or increasing the size of the array line and/or umbilical cables as desired. The underwater electrical module 146 may also harmonize the voltage from the electrical modules and may interconnect the plurality of alternating current (AC) or direct current (DC) sources. The underwater electrical module 146 may perform a DC to DC conversion, an AC to AC conversion, a DC to AC conversion, or an AC to DC conversion, as required. A local electrical distribution cable 150 provides a path for the electrical current routed to underwater electrical module 146 to be sent to an electrical substation, which according to an aspect of the disclosure is an offshore substation 152. Alternatively, the umbilical cable 130 and/or the array line 148 may be connected directly to the offshore substation 152 without requiring an underwater electrical module 146. The offshore substation 152 interconnects and directs the flow of electrical current from one or more underwater electrical modules 146. The offshore substation 152 may harmonize the voltage from the electrical modules and may interconnect the plurality of alternating current (AC) or direct current (DC) sources. The offshore substation 152 may perform a DC to DC conversion, an AC to AC conversion, a DC to AC conversion, or an AC to DC conversion, as required. The offshore substation 152 may provide a location for or a connection to energy storage 154, if desired. Such energy storage 154 may employ systems or technologies such as underwater pumped storage hydraulic technology, high-temperature thermal energy storage, a fly-wheel, one or more batteries such as a lithium-ion battery, compressed air storage, or other types of energy storage technologies. The offshore substation 152 may also include the capability for electrical isolation, as will be further described herein. The offshore substation 152 may send power to an onshore substation (not shown) through an export cable 156 for connection into a power grid 158 (FIG. 8). Alternatively or additionally, the offshore substation 152 may send power to power machinery located offshore. FIG. 8 is a top plan view of a representative layout of a power generation plant, according to disclosed aspects, in the form of a wind farm 160. The wind farm 160 includes twenty-five kites (indicated by their respective paths 118), five groups of umbilical lines 130 or array lines 148, five underwater electrical modules 146, five local electrical distribution cables 150, one offshore substation 152, and one export cable 156. Wind farm 160 may have any number of kites as desired, and the electric current produced by kites 112 may be electrically connected to export cable 156 through any combination or arrangement of electrical modules, substations, umbilical cables, and electrical distribution cables.

Aspects of the disclosure described above anchor kite 112 to the seafloor, thereby eliminating the heavy and expensive offshore towers, semi-submersible structures, and other permanent structures used in known offshore wind farms. However, in some circumstances it may be desirable to limit the range of motion of the kite with respect to the seafloor. FIG. 9 illustrates the use of a floating structure from which the kite 112 can rotate. The floating structure may be a tension leg platform, spar, semi-submersible structure, a ship-shaped floating structure, or as shown in FIG. 9, a buoy 162. The buoy 162 may be moored to the seafloor at a single point using tether line. Alternatively, multiple lines may be used to moor the buoy at multiple points on the seafloor. In this aspect, tether line 116 may be divided into an underwater portion 116c and an aloft portion 116d. Each of the portions may then be optimally designed to meet the tension load requirements and to withstand the conditions of its respective environment. Other types of floating structures or foundational members may be used instead of buoy 162, it being understood that such floating structures are anticipated to be much smaller than those used to support offshore windmill-type motor/generators. Additionally, buoy 162 may include basic electrical infrastructure in an electrical module 164 that results in further simplifying the structure and function of the underwater electrical module 146. Buoy 162 may also include electrical isolation capability as part of or separate from the electrical module 164 as will be explained below. The electrical module 164 and/or the electrical isolation capability, if provided separately, may be provided in a modular form factor which allows easy removal, installation, repair, and replacement. The electrical module 164 may include any or all of the communications, electrical isolation, and power conversion means as desired.

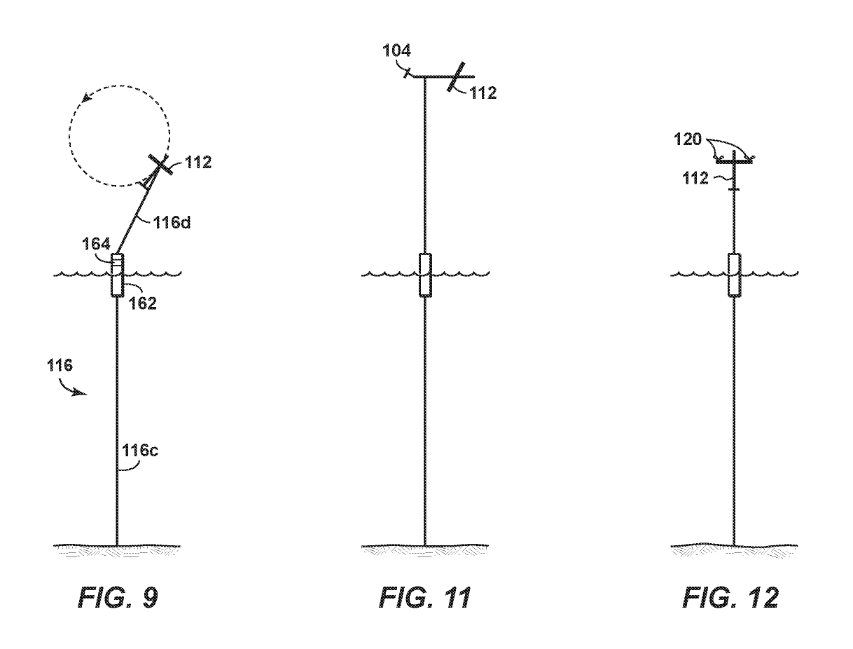

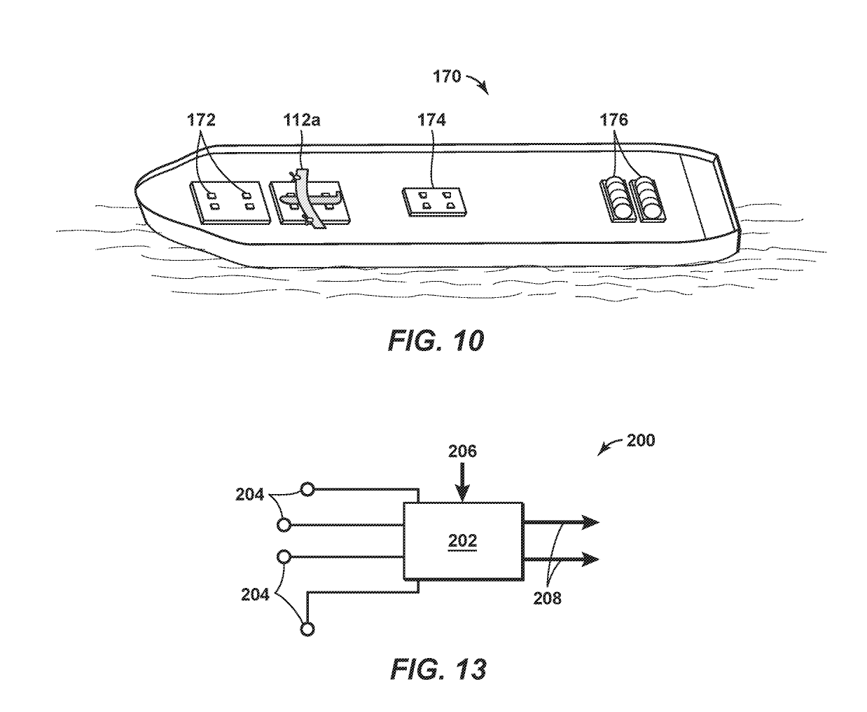

All of the aspects disclosed herein include a kite 112 tethered to the seafloor, and as such there is no fixed point on which the kite can be landed for maintenance, replacement, or when winds are too low or too high for kite to be effectively operated. Known kite systems (FIG. 1) employ a winch or spool to reduce the length of the tether line during such circumstances, but disclosed aspects use a tether line with a constant length between the kite and the anchor pile 136. In an aspect, kite 112 may be designed to land on the surface of the water 138 and be serviced by a vessel. According to aspects of the disclosure, kites 112 can be landed and transported on a specially outfitted movable structure, barge or vessel, such as an offshore support vessel 170 as depicted in FIGS. 2 and 10. The offshore support vessel is designed to move or be moved temporarily to locations where kites 112 have been installed. The offshore support vessel 170 may be outfitted with padded racks or bridles 172 upon which kites 112 may be transported. The offshore support vessel may also include a mount or perch 174 for landing and/or launching kites 112 without spooling or winching in the tether line, or in other words, the deployed length of the tether line (i.e., the length of the tether line between the anchor pile and the kite) is constant during landing and/or launching operations. The offshore support vessel module may additionally include spare tether lines 116, which may be wound around spools or drums 176 for storage in or on the offshore support vessel. Kites 112 may be controlled, through tether line 116 or via wireless communication/control systems onboard the offshore support vessel, to land on perch 174 for maintenance, repair or replacement. In such a landing operation, propellers 120 powered by motor/generators 122 may provide the required lift to maneuver the kite to the perch or to a water surface. A spare kite 112a could replace the landed kite if necessary. Offshore support vessel 170 could service and otherwise perform maintenance and repair on many kites in this manner, thereby eliminating the need for permanent offshore structures to land the kites for maintenance and repair, and eliminating the need to bring the kites onshore for much of the required maintenance and repair thereon. Such onsite installation, removal, service, maintenance, and repair may result in significant cost savings during commissioning, start-up, long-term operation, etc.

Another reason known tethered kites have relied upon permanent support structures is to protect the kite from potentially damaging high winds and from situations in which the wind speed is too low to either hold the kite aloft or to generate an acceptable level of power. According to disclosed aspects shown in FIG. 11, kite 112 may be programmed to hover horizontally during times of high winds. Kite 112 is shown as having a significant wing shape, which should provide sufficient lift in a high wind situation to keep the kite airborne. Additionally, rear stabilizer 104 may provide lift as well as stability to kite 112 in this situation. On the other hand, kite 112 may be programmed or controlled to hover vertically during times of low winds, as shown in FIG. 12. Propellers 120, powered by motor/generators 122 (shown in FIG. 3), may provide sufficient lift to maintain kite 112 aloft. Motor/generators 122 may be powered by an external power source or through stored power. Alternatively, kite 112 may be programmed or controlled to land on the surface of the water during periods of low winds, tether failure, or loss of grid power.

It is anticipated that the tether line 116 could carry electrical power in the range of thousands of volts AC or DC at energy levels of tens of kilowatts to tens of megawatts. Many scenarios exist where the kite 112 or its respective tether line 116 could come into unwanted electrical conduction with the surrounding water or other structures, craft and the like. Aspects disclosed herein include consideration of such electrical safety issues. For example, sensors may be used to detect parameters associated with the kite 112, its surroundings, and its associated power system. Such parameters may include electrical parameters, such as voltage, lack of voltage, current, current loss, corona discharge, and current and/or voltage unbalance. Such electrical parameters may be measured at any location of the disclosed system. Other detected parameters may include signals indicating degradation of the tether line, altitude of the kite, tension of the tether line, wind speed, height and/or frequency of waves in the body of water in which the kite is installed, the receiving or loss of a trip command from a remote device, the detection of craft or personnel in or approaching the kite, or the presence or absence of a remote signal. Sensors to detect such parameters may include one or more current sensors, voltage sensors, tension monitoring devices, strain gauges, wind meters, communication units, gyroscopes, altimeters, speed sensors, vibration sensors, camera systems, radar, and the like. The detected parameters may be used to determine whether the kite 112 and associated power systems should be switched to a failsafe operating mode or electrical safe state, which in an aspect may be termed a “safe park condition.” The safe park condition may include an electrically safe state or condition. This safe park condition is one which may include de-energizing the tether line 116. De-energizing the tether may include tripping electrical circuit breakers or activating electrical interrupting devices, and/or turning off the triggering to power electronics devices, which may include gated power electronics such as thyristors and the like. Transition to the safe park condition may include ending power transmission from the kite 112 into the tether line 116 by ending or interrupting electrical conduction to the tether line 116 from the generating source or sources located on the kite, and vice versa.

The safe park condition may include ending electrical conduction from the offshore power system by interrupting the electrical connection at any point between offshore substation 152 and kite 112. The safe park condition may also include grounding the umbilical cable 130 associated with tether line 116. To facilitate transfer to a safe park condition, electrical switching, interrupting or isolating means should be in electrical communication (preferably in series) with both the first end 116a and the second end 116b of the tether line 116. The electrical switching, interrupting or isolating means may be in the form of circuit breakers, pyrotechnic interrupters, switches, power circuit electronics, fuses, grounding switches, and the like.

The decision to transition to an electrical safe state, such as the safe park condition, may be incorporated in to the normal operational steps of the kite 112. For example, if a winged kite 112 were to execute a landing on an offshore support vessel 170, a transition to the safe park condition may be included as one of the manual or automatically initiated steps of its control system. By way of example, a kite 112 using power from an offshore power system may be programmed or otherwise instructed to operate the motor/generators 122 in a motoring mode (used, e.g., to descend the kite to an offshore supply vessel 170 or to hover the kite during a low wind condition). In such a circumstance, the transition to a safe park condition may be initiated to electrically isolate the tether line from electrical conduction from both the kite and the offshore power system.

According to disclosed aspects, electrical switching, interrupting or isolating means may be located at the buoy 162 (if used), in the underwater electrical module 146 as shown by reference number 146a, at the offshore substation 152 (if used) as shown by reference number 152a, on or in tether line 116 as shown by reference number 117, or elsewhere in power generation system 100. Transitioning to the safe park condition may include operating (e.g. opening) the electrical switching, interrupting or isolating means upon receipt of a command from a supervisory control system or via a manual command. FIG. 13 is a schematic of a representative control system 200 that may be used to initiate a safe park condition or other failsafe mode. Control system 200 may reside on the kite 112, but may advantageously reside on both the kite and a location not on the kite, such as the buoy 162, underwater electrical module 146, and/or offshore substation 152. Control system 200 may be incorporated into the control system (not shown) used to control flight and autonomous operation of the kite, or alternatively may be independent from other functions. Control system 200 may include a programmable controller 202, such as an electrically protective relay or a programmable logic controller, which receives input from various sensors 204 as have been previously described. Decision logic may be input at 206 into controller 202 according to known programming principles. Instructions to transition to an electrical safe state, such as the described safe park condition, are output at 208 to the buoy 162, underwater electrical module 146, and/or the offshore substation 152 as required. Such output instructions communicate the trigger to the safe park condition when the predetermined requirements for such trigger or transition are sensed, determined, or otherwise requested.

An example of a situation in which an electrical failsafe mode may be helpful is if the tether line 116 breaks while the kite 112 is generating power. Sensors 204, such as current and voltage sensors on the kite, power monitor calculations in the control system of the kite 112, and/or tension monitors associated with the tether 116 itself, may provide inputs to the programmable controller 202 of the control system 200. The programmable controller 202 processes the input(s) using decision logic 206 to determine that an abnormal condition has occurred, and will then communicate through outputs 208 to initiating the safe park condition. The tether 116 can thus be safely electrically isolated.

In an aspect, conditions requiring electrical isolation are sensed, detected or calculated prior to when an abnormality is detected. It may be desirable for electrical isolation to occur before any abnormal current flow or voltage variation is detected. According to one aspect, the system may anticipate that current carrying conductors or components are approaching an increased risk of electrical fault (e.g., impact with the surface of a body of water). By way of example, sensing an undesirable condition may include sensing a position or calculating the trajectory of the kite or the tether line, and electrical isolation may be performed automatically in response to the anticipated trajectory or position of the kite, prior to an electrical anomaly being detected by sensors 204.

The disclosed aspects have many advantages when compared with known wind energy solutions. Such advantages include significant weight reduction, manufacturing and installation cost, ability to harness wind energy at high altitudes, and the ability to harness wind energy inexpensively at extreme water depths. As such, aspects of the disclosure may be used to not only supply power to a power grid, but may also be used to power any type of offshore project, such as aquaculture or desalination. As another example, aspects of the disclosure may be used to access new oil and/or gas reservoirs adjacent existing an offshore oil and gas facility. If the most cost-effective way to develop the new reservoirs is to leverage the existing infrastructure, there will likely be additional power requirements for such development, especially if the development has significant subsea components. Since the original offshore oil and gas facility likely was not designed with the additional power requirements in mind, it may be expensive and time-consuming to meet the additional power requirements. The disclosed aspects enable additional power generating capacity to be added to the existing offshore facility at a reasonable cost.

Aspects of the disclosure may also advantageously be used with new offshore oil and gas projects that require power generation to operate. An offshore platform or facility may be economically powered at least in part by one or more kites as disclosed herein. Such kite-based power is especially attractive for subsea production that leverages existing processing, storage and/or transportation facilities that are a long way (>50 km) from existing subsea production and/or processing infrastructure.

Aspects described herein may have other advantageous applications. For example, the disclosed aspects may be used with other power sources, including other renewable sources such as solar, tidal, thermal, geothermal, and the like, to power equipment used in subsea boosting or to be used when one of the renewable sources is not available because of low winds, low available solar energy, grid loss, etc.

The disclosed aspects have described a tether line secured at one end to a seafloor and at the other end to a kite. It is to be understood that such a tether line may actually be two separate lines—for example, an underwater portion and an aloft portion—that function together to secure the kite to the seafloor and transmit power generated by movement of the kite to the electrical transmission system. While the two separate lines may have different lengths, diameters, and compositions, for the purposes of this disclosure such separate tether lines or tether line portions may be considered to be a single tether line.

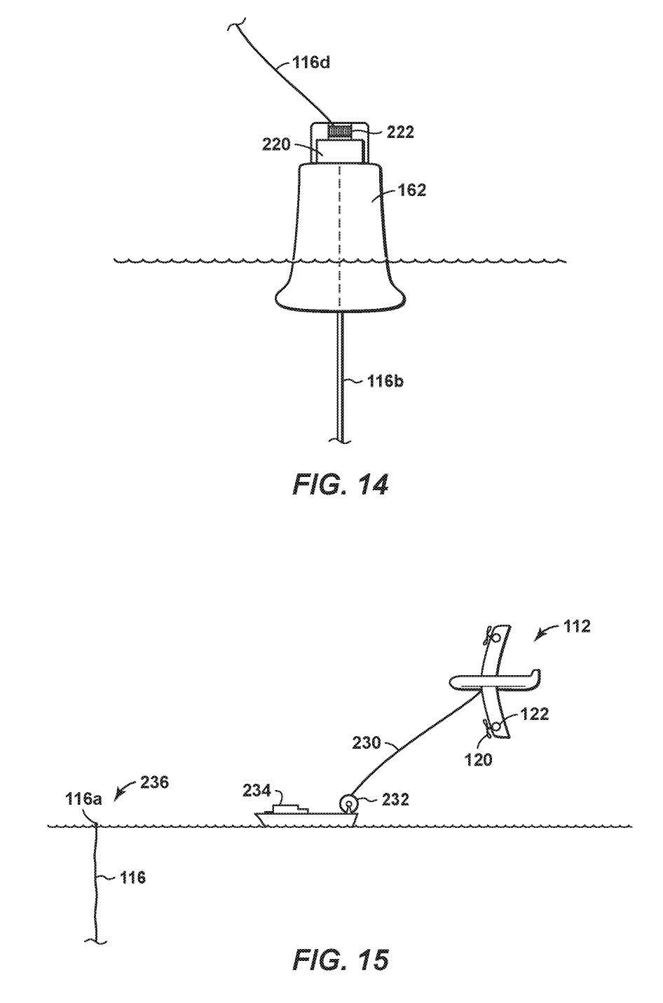

FIG. 14 depicts another aspect of the disclosure in which a motor/generator 220 is located at the buoy 162 instead of at the kite. A spool 222 is rotatably connected to motor/generator 220. Aloft portion 116d of the tether line is configured to be wound and unwound around spool 222. When motor/generator 220 acts as a motor, aloft portion 116d of the tether line winds around spool 222. When spool 222 is directed to unwind the aloft portion of the tether line, the motor/generator 220 generates power that is transmitted through umbilical cable 116b to the electrical transmission system (not shown).

Because the kite 112 is light and capable of creating aerodynamic lift, it is much easier to transport and install. FIG. 15 is a schematic illustration of how kite 112 may be transported to or from an installation site. As shown in FIG. 15, kite 112 may be attached to a tow cable 230 that is at least partially wound around a spool 232. In this disclosed aspect, the spool 232 is mounted on a small vessel or boat 234. Using tow cable 230, small boat 234 may tow the kite 112 from land or from an offshore support vessel to an installation site 236, which is typically at a wind farm or other power generation site. Kite 112 may be maintained aloft using motor/generator 122 and the propellers 120, principles of aerodynamic lift, or both. When the small boat 234 reaches the installation site 236, tow cable 230 is reeled in until the kite is close enough to secure first end 116a of tether line 116 to the kite. The kite may then ascend into the air to generate power as previously described. This procedure may be reversed if a kite is to be removed from an installation site to a land-based landing site, an offshore supply vessel, or other location. The method of transportation and installation/de-installation depicted in FIG. 15 and described herein is an alternative to using a much larger offshore supply vessel 170. Alternatively, as described above, an offshore supply vessel may serve primarily to transport kites 112 to and from the general vicinity of their respective installation sites, and one or more small boats 234 may transport kites 112 to and from the offshore supply vessel to install the kites at their respective installation sites.

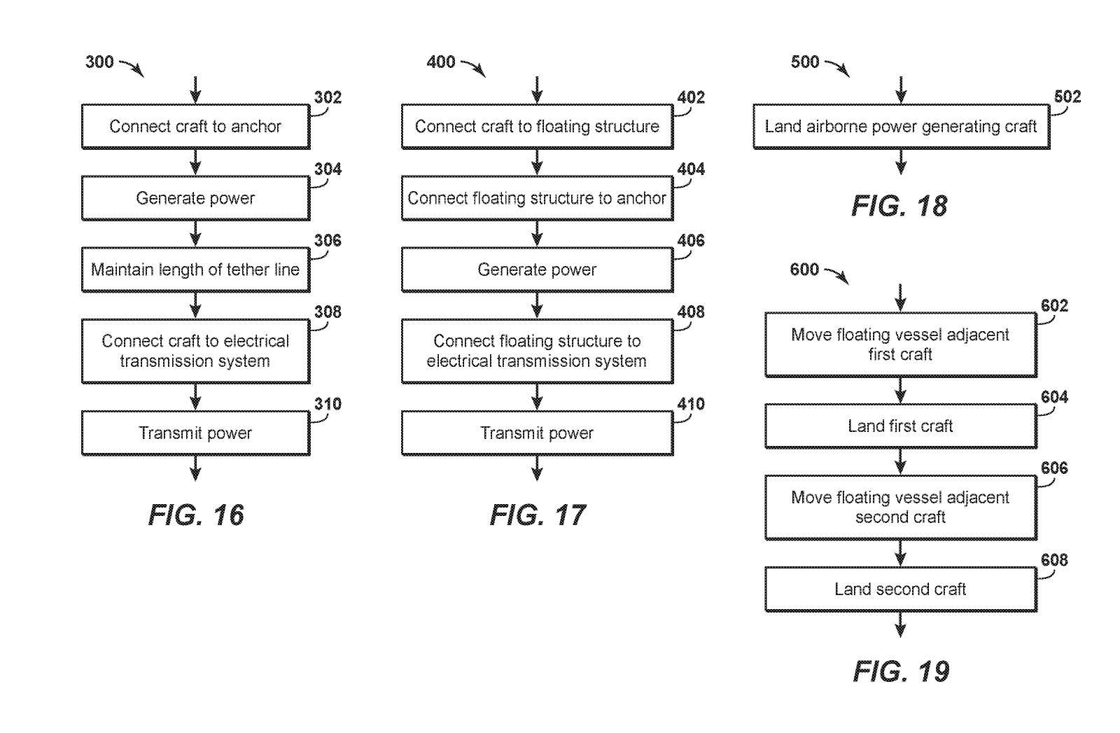

FIG. 16 is a flowchart of a method 300 of generating power according to disclosed aspects. At block 302 an airborne power generating craft is connected to an anchor using a tether line. The anchor is secured to an underwater floor. At block 304 power is generated based on movement of the airborne power generating craft in response to a wind force. At block 306 a constant length of the tether line is maintained between the airborne power generating craft and the anchor as the airborne power generating craft moves in response to the wind force. At block 308 the airborne power generating craft is connected to an electrical transmission system through at least part of the tether line. At block 310 the generated power is transmitted to the electrical transmission system.

FIG. 17 is a flowchart of a method 400 of generating power according to disclosed aspects. At block 402 an airborne power generating craft is connected to a floating structure, such as a buoy, using an aloft portion of a tether line. At block 404 the floating structure is connected to an anchor using an underwater portion of the tether line. The anchor is secured to an underwater floor. At block 406 power is generated based on movement of the airborne power generating craft in response to a wind force. At block 408 the floating structure is connected to an electrical transmission system through at least part of the tether line. At block 410 the generated power is transmitted to the electrical transmission system.

FIG. 18 is a flowchart of a method 500 of maintaining an offshore power plant according to disclosed aspects. At block 502 a plurality of airborne power generating craft are landed on or near a floating vessel. Each of the plurality of airborne power generating craft forms part of the offshore power plant.

FIG. 19 is a flowchart of a method 600 for maintaining an offshore power plant according to disclosed aspects. The offshore power plant has a first airborne power generating craft and a second airborne power generating craft. At block 602 the floating vessel is moved to a position adjacent the first airborne power generating craft. At block 604 the first airborne power generating craft is landed on or near the floating vessel. At block 606 the floating vessel is moved to a location adjacent the second airborne power generating craft. At block 608 the second airborne power generating craft is landed on or near the floating vessel.

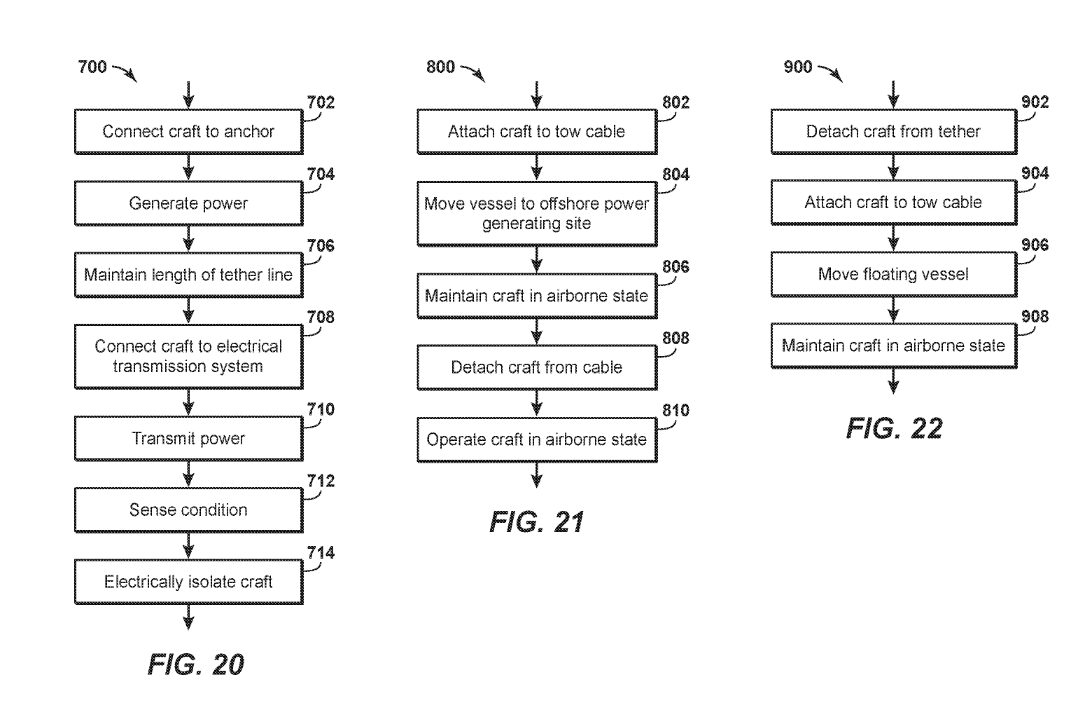

FIG. 20 is a flowchart of a method 700 for generating power according to disclosed aspects. At block 702 an airborne power generating craft is connected to an anchor using a tether line. The anchor is secured to an underwater floor. At block 704 power is generated based on movement of the airborne power generating craft in response to a wind force. At block 706 a constant length of the tether line is maintained between the airborne power generating craft and the anchor as the airborne power generating craft moves in response to the wind force. At block 708 the airborne power generating craft is connected to an electrical transmission system through at least part of the tether line. At block 710 the generated power is transmitted to the electrical transmission system. At block 712 a condition is sensed in which transmitting power to the electrical transmission system is not desired. At block 714 the airborne power generating craft is electrically isolated to prevent power from being transmitted from the airborne power generating craft to the electrical transmission system.

FIG. 21 is a flowchart of a method 800 of maintaining an offshore power plant according to disclosed aspects. At block 802 a power generating craft is attached to a tow cable on a floating vessel. At block 804 the floating vessel is moved to an offshore power generating site. At block 806 the power generating craft is maintained in an airborne state while the floating vessel is moving to the offshore power generating site. At block 808 the power generating craft is detached from the tow cable and attached to a first end of a tether line at the offshore power generating site. A second end of the tether line is anchored to an underwater floor. At block 810 operating the power generating craft is operated in an airborne state.

FIG. 22 is a flowchart of a method 900 of maintaining an offshore power plant according to disclosed aspects. At block 902 detaching a power generating craft from a first end of a tether line at an offshore power generating site. A second end of the tether line is anchored to an underwater floor. At block 904 the power generating craft is attached to a tow cable on a floating vessel. At block 906 the floating vessel is moved away from the offshore power generating site. At block 908 the power generating craft is maintained in an airborne state while the floating vessel is moving away from the offshore power generating site.

Disclosed aspects may include any combinations of the methods and systems shown in the following numbered paragraphs. This is not to be considered a complete listing of all possible aspects, as any number of variations can be envisioned from the description above.

A1. An offshore power generation system, comprising:

an airborne power generating craft;

a tether line connected at a first end to the airborne power generating craft, the tether line having a length;

an anchor to which a second end of the tether line is attached, the anchor being secured to an underwater floor, wherein the tether line has a constant length between the airborne power generating craft and the anchor; and

an electrical transmission system connected to the airborne power generating craft through the tether line, the electrical transmission system being configured to transmit power generated by the airborne power generating craft.

A2. The offshore power generation system of paragraph A1, wherein the airborne power generating craft comprises a structure that moves in response to a wind force.
A3. The offshore power generation system of paragraph A2, wherein the structure is one of a kite, wing, or blade.
A4. The offshore power generation system of paragraph A2, further comprising:

a motor/generator attached to the structure and electrically connected to the electrical transmission system through the tether line; and

a propeller rotatably attached to the motor/generator, wherein the propeller is configured to rotate in response to movement of the structure to thereby generate power in the motor/generator.

A5. The offshore power generation system of any of paragraphs A1-A4, wherein the anchor is an anchor pile.
A6. The offshore power generation system of paragraph A5, wherein the anchor pile is located entirely underwater.
A7. The offshore power generation system of paragraph A5, wherein the anchor pile is partially underwater and partially above a water surface.
A8. The offshore power generation system of any of paragraphs A1-A7, further comprising a rotating element attached to the anchor, wherein the second end of the tether line is secured to the rotating element to permit relative movement of the tether line with respect to the anchor.
A9. The offshore power generation system of any of paragraphs A1-A8, wherein the tether line comprises:

a tension element configured to secure the airborne power generating craft to the anchor; and

an electrically conductive umbilical cable configured to transmit at least one of power and control signals between the airborne power generating craft and the electrical transmission system.

A10. The offshore power generation system of paragraph A9, wherein the umbilical cable is separate from the tension element beginning at an underwater point of separation.
A11. The offshore power generation system of any of paragraphs A1-A10, wherein the electrical transmission system comprises:

an underwater electrical module connected to the umbilical cable, the underwater electrical module performing at least one of voltage transformation, power distribution, breaker switching, communication, control, and power isolation; and

an offshore substation electrically connected to the underwater electrical module, the offshore substation performing at least one of voltage harmonization, direct current (DC) to DC conversion, DC to alternating current (AC) conversion, AC to DC conversion, and AC to AC conversion.

A12. The offshore power generation system of any of paragraphs A1-A11, wherein the airborne power generating craft is one of a plurality of airborne power generating craft, each of the plurality of airborne power generating craft having an electrically conductive umbilical cable associated therewith, and the underwater electrical module is a first underwater electrical module, and further comprising:

the first underwater electrical module electrically connected to umbilical cables associated with a first group of the plurality of airborne power generating craft;

a second underwater electrical module electrically connected to umbilical cables associated with a second group of the plurality of airborne power generating craft, each of the first and second underwater electrical modules performing at least one of voltage transformation, power distribution, breaker switching, communications, control, and power isolation; and

an offshore substation electrically connected to the first and second underwater electrical modules, the offshore substation performing at least one of voltage harmonization, direct current (DC) to DC conversion, DC to alternating current (AC) conversion, AC to DC conversion, and AC to AC conversion.

A13. The offshore power generation system of any of paragraphs A1-A12, further comprising an energy storage system connected to the electrical transmission system and configured to store power generated by the airborne power generating craft.
A14. The offshore power generation system of paragraph A13, wherein the energy storage system is one or more of an underwater pumped storage hydraulic system, a thermal energy storage system, a fly-wheel, a battery, and a compressed air storage system.
A15. The offshore power generation system of any of paragraphs A1-A14, wherein the electrical transmission system is connected to an energy grid to transmit the power generated by the airborne power generating craft thereto.
A16. The offshore power generation system of any of paragraphs A1-A15, wherein the tether line comprises:

an underwater section configured to be underwater when the tether line is attached to the airborne power generating craft and to the anchor; and

an aloft section configured to be above a water surface when the tether line is attached to the airborne power generating craft and to the anchor;

wherein the underwater section and the aloft section are made of different materials.

A17. The offshore power generation system of any of paragraphs A1-A16, wherein the length of the tether line above a water surface is at least 300 meters.
A18. A method of generating power, comprising:

connecting an airborne power generating craft to an anchor using a tether line, the anchor being secured to an underwater floor;

generating power based on movement of the airborne power generating craft in response to a wind force;

maintaining a constant length of the tether line between the airborne power generating craft and the anchor as the airborne power generating craft moves in response to the wind force;

connecting the airborne power generating craft to an electrical transmission system through at least part of the tether line; and

transmitting the generated power to the electrical transmission system.

A19. The method of paragraph A18, further comprising: storing power generated by the airborne power generating craft in an energy storage system connected to the electrical transmission system.
A20. The method of paragraph A19, wherein the energy storage system is selected from an underwater pumped storage hydraulic system, a thermal energy storage system, a fly-wheel, a battery, and a compressed air storage system.
A21. The method of any of paragraphs A18-A20, wherein connecting the airborne power generating craft to the anchor using a tether line is accomplished using a tension element forming part of the tether line and connected to the airborne power generating craft and to the anchor comprises securing the airborne power generating craft to the anchor using a tension element that forms part of the tether line, and wherein the at least part of the tether line connecting the airborne power generating craft to the electrical transmission system comprises an electrically conductive umbilical cable configured to transmit at least one of power and control signals between the airborne power generating craft and the electrical transmission system.
A22. The method of paragraph A21, further comprising separating the umbilical cable from the tension element at an underwater point of separation.
A23. The method of any of paragraphs A18-A22, further comprising:

connecting an underwater electrical module connected to the umbilical cable;

performing, at the underwater electrical module, at least one of voltage transformation, power distribution, breaker switching, communication, control, and power isolation;

electrically connecting an offshore substation to the underwater electrical module; and

performing, at the offshore substation, at least one of voltage harmonization, direct current (DC) to DC conversion, DC to alternating current (AC) conversion, AC to DC conversion, and AC to AC conversion.

A24. The method of any of paragraphs A18-A23, wherein the airborne power generating craft is one of a plurality of airborne power generating craft, each of the plurality of airborne power generating craft having an electrically conductive umbilical cable associated therewith, and the underwater electrical module is a first underwater electrical module, and further comprising:

electrically connecting the first underwater electrical module to umbilical cables associated with a first group of the plurality of airborne power generating craft;

electrically connecting a second underwater electrical module to umbilical cables associated with a second group of the plurality of airborne power generating craft;

wherein each of the first and second underwater electrical modules performs at least one of voltage transformation, power distribution, breaker switching, communications, control, and power isolation; and

electrically connecting the first and second underwater electrical modules to an offshore substation, the offshore substation performing at least one of voltage harmonization, direct current (DC) to DC conversion, DC to alternating current (AC) conversion, AC to DC conversion, and AC to AC conversion.

A25. The method of any of paragraphs A18-A24, further comprising:

connecting the electrical transmission system to an energy grid; and

transmitting the power generated by the airborne power generating craft to the energy grid.

A26. The method of any of paragraphs A18-A25, further comprising:

operating the airborne power generating craft in a glide mode when a wind speed is greater than a first predetermined wind speed; and

operating the airborne power generating craft in a non-power-generating hover mode when the wind speed is less than a second predetermined wind speed, wherein the second predetermined wind speed is less than the first predetermined wind speed.

A27. The method of any of paragraphs A18-A26, further comprising:

landing the airborne power generating craft on a water surface when a wind speed is less than a predetermined wind speed.

It should be understood that the numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other.

What is claimed is:

1. An offshore power generation system, comprising:
an airborne power generating craft comprising a structure that moves in response to a wind force;
a tether line connected at a first end to the airborne power generating craft, the tether line having a length;
an anchor to which a second end of the tether line is attached, the anchor being secured to an underwater floor, wherein the tether line has a constant length between the airborne power generating craft and the anchor; and
an electrical transmission system connected to the airborne power generating craft through the tether line, the electrical transmission system being configured to transmit power generated by the airborne power generating craft.

2. The offshore power generation system of claim 1, wherein the structure is one of a kite, wing, or blade.

3. The offshore power generation system of claim 1, further comprising:
a motor/generator attached to the structure and electrically connected to the electrical transmission system through the tether line; and
a propeller rotatably attached to the motor/generator, wherein the propeller is configured to rotate in response to movement of the structure to thereby generate power in the motor/generator.

4. The offshore power generation system of claim 1, wherein the anchor is an anchor pile located entirely underwater.

5. The offshore power generation system of claim 1, wherein the anchor is an anchor pile located partially underwater and partially above a water surface.

6. The offshore power generation system of claim 1, further comprising a rotating element attached to the anchor, wherein the second end of the tether line is secured to the rotating element to permit relative movement of the tether line with respect to the anchor.

7. The offshore power generation system of claim 1, wherein the tether line comprises:
a tension element configured to secure the airborne power generating craft to the anchor; and
an electrically conductive umbilical cable configured to transmit at least one of power and control signals between the airborne power generating craft and the electrical transmission system.

8. The offshore power generation system of claim 7, wherein the umbilical cable is separate from the tension element beginning at an underwater point of separation.

9. The offshore power generation system of claim 1, wherein the electrical transmission system comprises:
an underwater electrical module connected to the umbilical cable, the underwater electrical module performing at least one of voltage transformation, power distribution, breaker switching, communication, control, and power isolation; and
an offshore substation electrically connected to the underwater electrical module, the offshore substation performing at least one of voltage harmonization, direct current (DC) to DC conversion, DC to alternating current (AC) conversion, AC to DC conversion, and AC to AC conversion.

10. The offshore power generation system of claim 1, wherein the airborne power generating craft is one of a plurality of airborne power generating craft, each of the plurality of airborne power generating craft having an electrically conductive umbilical cable associated therewith, and the underwater electrical module is a first underwater electrical module, and further comprising:
the first underwater electrical module electrically connected to umbilical cables associated with a first group of the plurality of airborne power generating craft;
a second underwater electrical module electrically connected to umbilical cables associated with a second group of the plurality of airborne power generating craft, each of the first and second underwater electrical modules performing at least one of voltage transformation, power distribution, breaker switching, communications, control, and power isolation; and
an offshore substation electrically connected to the first and second underwater electrical modules, the offshore substation performing at least one of voltage harmonization, direct current (DC) to DC conversion, DC to alternating current (AC) conversion, AC to DC conversion, and AC to AC conversion.

11. The offshore power generation system of claim 1, further comprising an energy storage system connected to the electrical transmission system and configured to store power generated by the airborne power generating craft, wherein the energy storage system is one or more of an underwater pumped storage hydraulic system, a thermal energy storage system, a fly-wheel, a battery, and a compressed air storage system.

12. The offshore power generation system of claim 1, wherein the tether line comprises:
an underwater section configured to be underwater when the tether line is attached to the airborne power generating craft and to the anchor; and
an aloft section configured to be above a water surface when the tether line is attached to the airborne power generating craft and to the anchor;
wherein the underwater section and the aloft section are made of different materials.

13. A method of generating power, comprising:
connecting an airborne power generating craft to an anchor using a tether line, wherein the anchor is secured to an underwater floor;
generating power based on movement of the airborne power generating craft in response to a wind force;
maintaining a constant length of the tether line between the airborne power generating craft and the anchor as the airborne power generating craft moves in response to the wind force;
connecting the airborne power generating craft to an electrical transmission system through at least part of the tether line; and
transmitting the generated power to the electrical transmission system.

14. The method of claim 13, further comprising: storing power generated by the airborne power generating craft in an energy storage system connected to the electrical transmission system, wherein the energy storage system is selected from an underwater pumped storage hydraulic system, a thermal energy storage system, a fly-wheel, a battery, and a compressed air storage system.

15. The method of claim 13, wherein connecting the airborne power generating craft to the anchor using a tether line is accomplished using a tension element forming part of the tether line and connected to the airborne power generating craft and to the anchor, and wherein the at least part of the tether line connecting the airborne power generating craft to the electrical transmission system comprises an electrically conductive umbilical cable configured to transmit at least one of power and control signals between the airborne power generating craft and the electrical transmission system.

16. The method of claim 15, further comprising separating the umbilical cable from the tension element at an underwater point of separation.

17. The method of claim 15, further comprising:
connecting an underwater electrical module connected to the umbilical cable;
performing, at the underwater electrical module, at least one of voltage transformation, power distribution, breaker switching, communication, control, and power isolation;
electrically connecting an offshore substation to the underwater electrical module; and
performing, at the offshore substation, at least one of voltage harmonization, direct current (DC) to DC conversion, DC to alternating current (AC) conversion, AC to DC conversion, and AC to AC conversion.

18. The method of claim 13, wherein the airborne power generating craft is one of a plurality of airborne power generating craft, each of the plurality of airborne power generating craft having an electrically conductive umbilical cable associated therewith, and the underwater electrical module is a first underwater electrical module, and further comprising:
electrically connecting the first underwater electrical module to umbilical cables associated with a first group of the plurality of airborne power generating craft;
electrically connecting a second underwater electrical module to umbilical cables associated with a second group of the plurality of airborne power generating craft;
wherein each of the first and second underwater electrical modules performs at least one of voltage transformation, power distribution, breaker switching, communications, control, and power isolation; and
electrically connecting the first and second underwater electrical modules to an offshore substation, the offshore substation performing at least one of voltage harmonization, direct current (DC) to DC conversion, DC to alternating current (AC) conversion, AC to DC conversion, and AC to AC conversion.

19. The method of claim 13, further comprising:
connecting the electrical transmission system to an energy grid; and
transmitting the power generated by the airborne power generating craft to the energy grid.

20. The method of claim 13, further comprising:
operating the airborne power generating craft in a glide mode when a wind speed is greater than a first predetermined wind speed; and
operating the airborne power generating craft in a non-power-generating hover mode when the wind speed is less than a second predetermined wind speed, wherein the second predetermined wind speed is less than the first predetermined wind speed.

21. The method of claim 13, further comprising:
landing the airborne power generating craft on a water surface when a wind speed is less than a predetermined wind speed.
